(19) United States
(12) Patent Application Publication
(10) Pub. No.: US 2026/0151964 A1
(43) Pub. Date: Jun. 4, 2026

(54) 3D PRINTER

(71) Applicant: Shenzhen Creality 3D Technology Co., Ltd., Shenzhen (CN)

(72) Inventors: Renjian QIU, Shenzhen (CN); Jingke Tang, Shenzhen (CN)

(21) Appl. No.: 19/365,482

(22) Filed: Oct. 22, 2025

(30) Foreign Application Priority Data
Nov. 29, 2024 (CN) 202422969079.0

(51) Int. Cl. B29C 64/35; B29C 64/241; B33Y 30/00; B33Y 40/00

(52) U.S. Cl. CPC B29C 64/35; B29C 64/241; B33Y 30/00; B33Y 40/00

(57) ABSTRACT

This application discloses a 3D printer, including a print head, a supporting assembly, a transmission assembly, and a pushing member. The supporting assembly comprises a material receiving area configured to receive excess material extruded from the print head. The transmission assembly is movably arranged on the supporting assembly. The pushing member rotatably is connected to the transmission assembly. A motion trajectory area of the pushing member covers at least a part of the material receiving area, and the transmission assembly is configured to drive the pushing member to rotate relative to the supporting assembly thereby pushing the excess material away from the supporting assembly.

### FIELD

The present disclosure relates to field of 3D printing technology, and in particular to a 3D printer.

### BACKGROUND

In existing 3D printer, some print heads need to completely extrude the consumable material inside a nozzle when performing material replacement or stopping operation. Some known print heads extrude the consumable material onto a receiving plate, where the consumable material solidifies to form excess material, and then collect the excess material through other structures, which results in low efficiency in removing the excess material.

Thus, there is room for improvement within the art.

### BRIEF DESCRIPTION OF THE DRAWINGS

Many aspects of the disclosure can be better understood with reference to the following drawings. The drawings in the following description are some embodiments of the present disclosure. For those of ordinary skill in the art, other drawings can be obtained based on these drawings without creative work.

FIG. 1 is a structural schematic view of a 3D printer according to an embodiment of the present application.

FIG. 2 is a structural schematic view of a part of the 3D printer.

FIG. 3 is a structural schematic view of a supporting assembly, a transmission assembly and a pushing member of the 3D printer.

FIG. 4 is a structural schematic view of the supporting assembly, the transmission assembly and the pushing member according to another embodiment of the present application.

FIG. 5 is an exploded structural schematic view of the supporting assembly, the transmission assembly and the pushing member according to an embodiment of the present application.

FIG. 6 is a structural schematic view of the supporting assembly, the transmission assembly and the pushing member according to an embodiment of the present application, wherein the pushing member is at a second position.

FIG. 7 is structural schematic view of the supporting assembly, the transmission assembly and the pushing member according to an embodiment of the present application, wherein the pushing member is at a first position.

FIG. 8 is a sectional view of a portion of the supporting assembly, the transmission assembly and the pushing member according to an embodiment of the present application.

FIG. 9 is an exploded structural schematic view of a base member and the transmission assembly according to an embodiment of the present application.

FIG. 10 is a sectional view of another portion of the supporting assembly, the transmission assembly and the pushing member according to an embodiment of the present application.

FIG. 11 is a structural schematic view of the supporting assembly and the transmission assembly according to an embodiment of the present application.

FIG. 12 is structural schematic view of the supporting assembly, the transmission assembly and the pushing member according to another embodiment of the present application.

FIG. 13 is a exploded structural schematic view of part of the supporting assembly, the transmission assembly and the pushing member according to an embodiment of the present application.

FIG. 14 is a sectional view of another portion of the supporting assembly, the transmission assembly and the pushing member according to an embodiment of the present application.

FIG. 15 is a sectional view of a connection portion between the supporting assembly and the pushing member according to an embodiment of the present application.

### DETAILED DESCRIPTION

In order to make the above-mentioned objects, features and advantages of the present application more obvious, a detailed description of specific embodiments of the present application will be described in detail with reference to the accompanying drawings. A number of details are set forth in the following description so as to fully understand the present application. However, the present application can be implemented in many other ways different from those described herein, and those skilled in the art can make similar improvements without violating the contents of the present application. Therefore, the present application is not to be considered as limiting the scope of the embodiments described herein.

Several definitions that apply throughout this disclosure will now be presented.

The term “coupled” is defined as coupled, whether directly or indirectly through intervening components, and is not necessarily limited to physical connections. The connection may be such that the objects are permanently coupled or releasably coupled. The term “substantially” is defined to be essentially conforming to the particular dimension, shape, or other feature that the term modifies, such that the component need not have that exact feature. The term “comprising,” when utilized, means “including, but not necessarily limited to”; it in one embodiment indicates open-ended inclusion or membership in the so-described combination, group, series, and the like.

Unless otherwise defined, all technical and scientific terms used herein have the same meaning as commonly understood by one skilled in the art. The terms used in a specification of the present application herein are only for describing specific embodiments and are not intended to limit the present application. The terms "and/or" used herein includes any and all combinations of one or more of associated listed items.

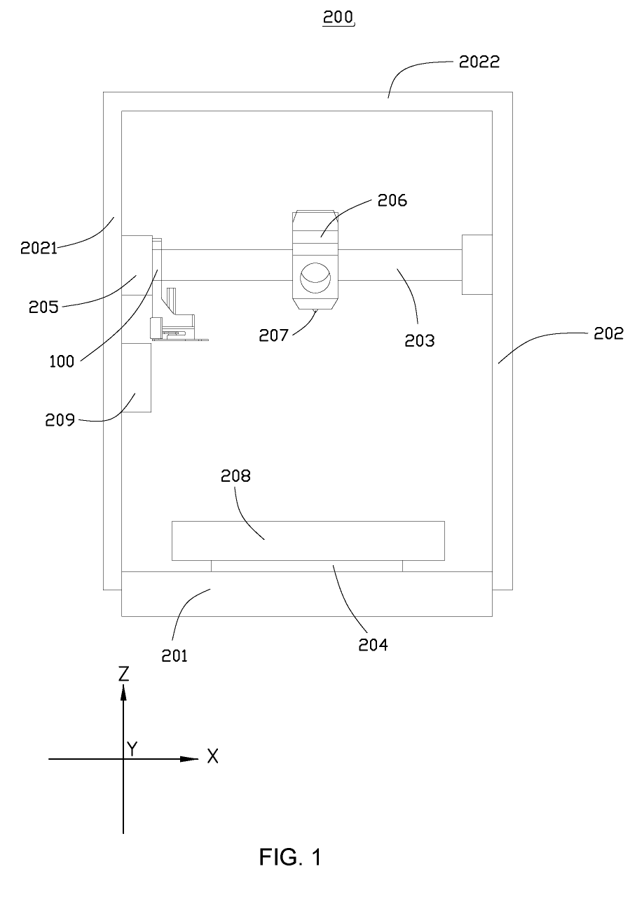

Referring to FIG. 1, an embodiment of the present application discloses a 3D printer 200. The 3D printer 200 may be a 3D printer based on FDM technology.

The 3D printer 200 includes a base 201, a frame 202, an X-axis drive assembly 203, a Y-axis drive assembly 204, a Z-axis drive assembly 205, a print head 206, a forming platform 208, a supporting assembly 10, a transmission assembly 20, and a pushing member 30.

The frame 202 is fixedly connected to the base 201. The Z-axis drive assembly 205 is connected to the frame 202, the X-axis drive assembly 203 is connected to the Z-axis drive assembly 205, and the print head 206 is connected to the X-axis drive assembly 203. The print head 206 is provided with a nozzle 207, the nozzle 207 is configured to extrude consumable material. The Y-axis drive assembly 204 is connected to the base 201 and is drivingly connected to the forming platform 208.

Therefore, relative displacement between the print head 206 and the forming platform 208 may be achieved in the first direction X, the second direction Y, and the third direction Z, allowing the print head 206 to extrude consumable material onto the forming platform 208 and print a three-dimensional object.

In other embodiments, movable directions of the forming platform 208 and the print head 206 may also take other forms, which are not limited here. For example, the Z-axis drive assembly 205 may be arranged on the base 201 and connected to the forming platform 208. The print head 206 is connected to the frame 202 via a bidirectional drive structure in the first direction X and the second direction Y, comprising the X-axis drive assembly 203 and the Y-axis drive assembly 204.

The 3D printer 200 is further provided with an excess material collection member 209, the excess material collection member 209 is arranged at one side of the supporting assembly 10. The excess material collection member 209 is configured to receive and collect excess material pushed out from the supporting assembly 10 by the pushing member 30. An excess material collection device may be arranged at the excess material collection member 209, and the excess material collection device may be configured to guide the excess material to move out of the 3D printer 200, achieving efficient excess material collection.

The supporting assembly 10 is connected to the frame 202, and is configured to support excess material extruded from the print head 206 and push the excess material to the excess material collection member 209.

In some embodiments, referring to FIG. 1, the frame 202 includes a beam 2022 and two posts 2021 spaced apart along a first direction X, with the beam 2022 connected between the two posts 2021. Each of the two posts 2021 is provided with a Z-axis drive assembly 205. The supporting assembly 10 is connected to one of the Z-axis drive assemblies 205, so that the Z-axis drive assembly 205 can drive the supporting assembly 10 and the X-axis drive assembly 203 to move synchronously along a third direction Z, enabling the print head 206 to reach the supporting assembly 10 by moving along the first direction X and perform the excess material extrusion operation, thereby further improving the efficiency of excess material collection.

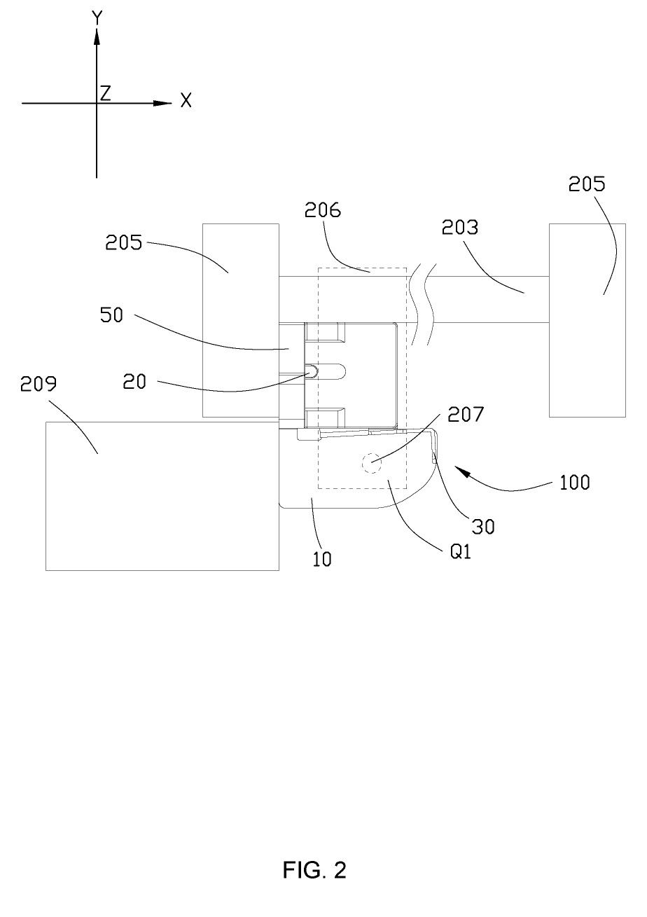

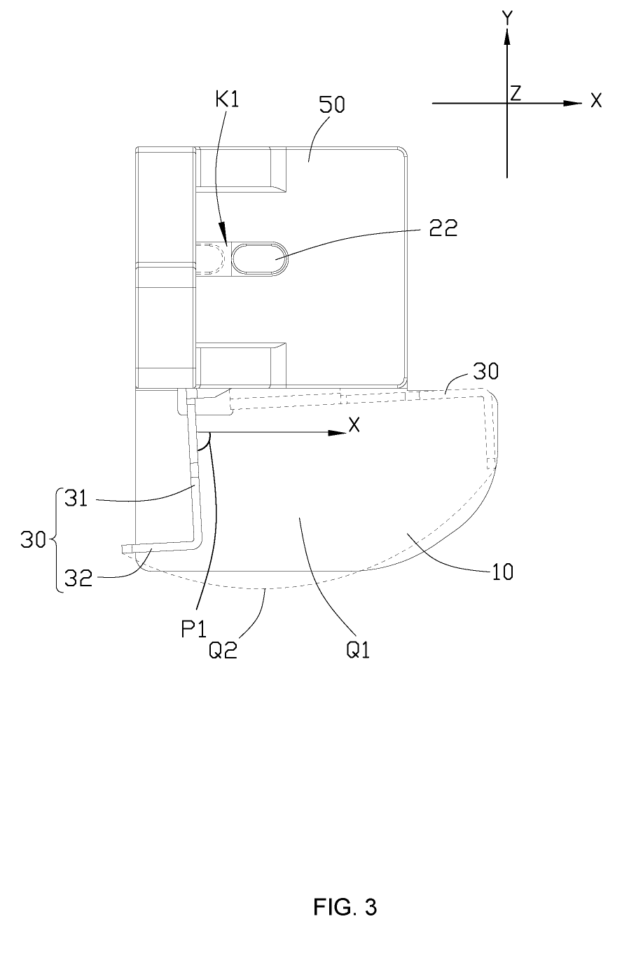

Referring to FIG. 2 and FIG. 3, the supporting assembly 10 includes a material receiving area Q1 configured to receive excess material extruded from the nozzle 207. The transmission assembly 20 is movably arranged on the supporting assembly 10. The pushing member 30 is rotatably connected to the transmission assembly 20, with a motion trajectory area Q2 of the pushing member 30 covering the material receiving area Q1, and the transmission assembly 20 is configured to drive the pushing member 30 to rotate relative to the supporting assembly 10 thereby pushing the excess material away from the supporting assembly 10.

In a case that the print head 206 needs to replace consumable material or stop printing, the print head 206 moves to a position above the material receiving area Q1 along the third direction Z, and extrudes residual consumable material inside the print head 206 through the nozzle 207, where the extruded consumable material solidifies on the supporting assembly 10 to form excess material. Subsequently, the transmission assembly 20 is triggered and drives the pushing member 30 to rotate relative to the supporting assembly 10. During the rotation of the pushing member 30 within the motion trajectory area Q2, the pushing member 30 can drive the excess material on the material receiving area Q1 to move along the motion trajectory area Q2 and finally push the excess material away from the supporting assembly 10, achieving rapid removal of excess material and improving the efficiency of excess material removal.

Furthermore, since the pushing member 30 and the supporting assembly 10 have a relative rotational movement relationship, the area of the motion trajectory area Q2 of the pushing member 30 is fixed, the area of the material receiving area Q1 of the supporting assembly 10 may be further reduced, thereby reducing the occupied space of the supporting assembly 10, facilitating the miniaturization of the supporting assembly 10, and improving the space utilization rate within the 3D printer 200.

Furthermore, for some known consumable materials that have strong adhesion to the surface of the supporting assembly 10 after falling onto the supporting assembly 10, the triggered transmission assembly 20 driving the pushing member 30 to move can provide sufficient force to separate the excess material from the supporting assembly 10, thereby ensuring the effectiveness of excess material removal.

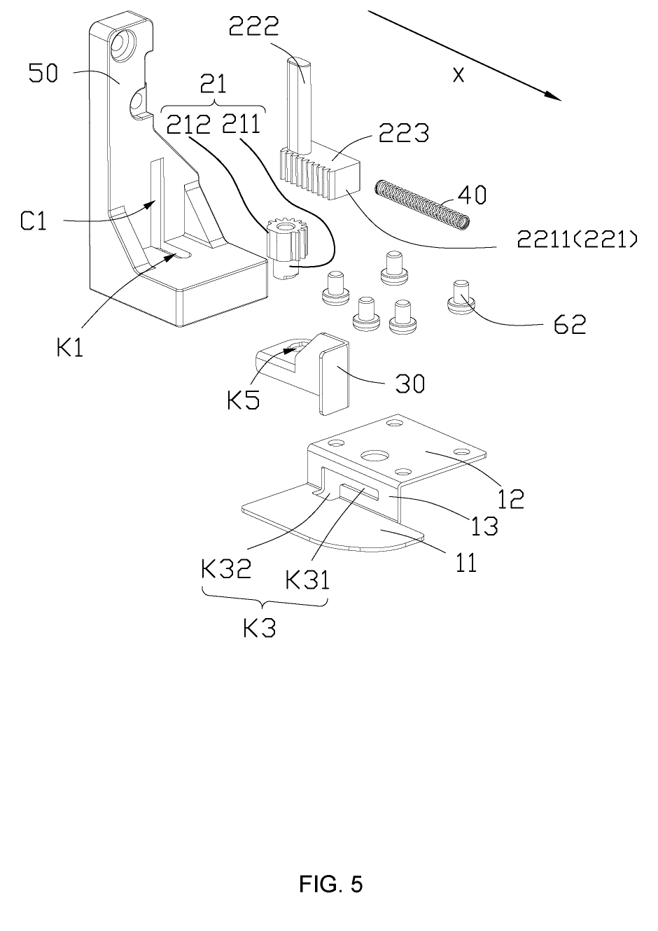

In some embodiments, referring to FIG. 5, the transmission assembly 20 includes a transmission member 21 and a force receiving member 22, one end of the transmission member 21 is transmission-connected to the force receiving member 22, and another end of the transmission member 21 is connected to the pushing member 30, and the force receiving member 22 is configured to drive the transmission member 21 to move relative to the supporting assembly 10 in response to the force receiving member 22 is pushed by the print head 206, thereby driving the pushing member 30 to rotate relative to the supporting assembly 10.

The movement of the print head 206 is able to drive the pushing member 30 to rotate relative to the supporting assembly 10, thereby achieving the removal of excess material by the pushing member 30. As such, there is no need to set up separate drive structures such as motors to drive the rotation of the pushing member 30, reducing the cost of the 3D printer 200, and no additional detection elements are needed to detect the material extrusion action of the print head 206, thereby reducing control costs. In other embodiments, the transmission assembly 20 may include a drive structure such as a motor, or the supporting assembly 10 may be movably connected to the frame 202, controlling the movement of the supporting assembly 10 relative to the frame 202 to cause collision between the force receiving member 22 and the frame 202, thereby achieving the movement of the pushing member 30 relative to the supporting assembly 10. There are multiple ways to achieve the transmission assembly 20 driving the pushing member 30 to rotate, and embodiments of the disclosure do not limit them.

In some embodiments, referring to FIG. 5, the force receiving member 22 includes a force receiving portion 222 and a first transmission portion 221. The force receiving portion 222 is connected to the first transmission portion 221, and the force receiving portion 222 is configured to drive the first transmission portion 221 to move in response to the force receiving portion is pushed by the print head 206. The transmission member 21 includes a second transmission portion 211, the second transmission portion 211 is rotatably connected to the first transmission portion 221, the second transmission portion 211 is connected to the pushing member 30, and the first transmission portion is configured to drive the second transmission portion 211 to rotate, thereby driving the pushing member 30 to rotate relative to the supporting assembly 10.

In some embodiments, referring to FIG. 5, the first transmission portion 221 may be a first rack 2211, the second transmission portion 211 may be a first gear 2111, the first gear 2111 meshes with the first rack 2211, one end of the pushing member 30 is fixedly connected to the first gear 2111, and another end of the pushing member 30 extends above the supporting assembly 10. A length direction of the first rack 2211 is parallel to the first direction X.

The X-axis drive assembly 203 is configured to drive the print head 206 to move along the first direction X, thereby driving the first rack 2211 to move along the first direction X, thereby driving the first gear 2111 to rotate, achieving the rotation of the pushing member 30 relative to the supporting assembly 10, where a fan-shaped area of the pushing member 30 rotating relative to the supporting assembly 10 is the motion trajectory area Q2.

In some embodiments, the first gear 2111 includes multiple teeth on a side facing the first rack 2211, while a side of the first gear 2111 away from the first rack 2211 is a plane, which can reduce a dimension of the first gear 2111 along the second direction Y, thereby further reducing the dimension of the force receiving member 22 along the second direction Y to improve the internal space utilization of the 3D printer 200.

In another embodiment, both the first transmission portion 221 and the second transmission portion 211 may be synchronous wheels, connected by a synchronous belt for transmission, and the second transmission portion 211 is fixedly connected to one end of the pushing member 30. The first transmission portion 221 further includes a rocker arm connected to the first transmission portion 221. The X-axis drive assembly 203 is configured to drive print head 206 to move along the first direction X, thereby driving the rocker arm to rotate, thereby driving the second transmission portion 211 to rotate through the first transmission portion 221 and the synchronous belt, achieving the rotation of the pushing member 30 relative to the supporting assembly 10.

In another embodiment, the first transmission portion 221 may be a second gear, the second transmission portion 211 may be a second rack, one end of the pushing member 30 is fixedly connected to the second rack, a rocker arm is connected to the second gear, the second rack extends along the first direction X, and the second rack meshes with the second gear. The X-axis drive assembly 203 is configured to drive the print head 206 to move along the first direction X, thereby driving the rocker arm to rotate, thereby driving the second rack to move along the first direction X through the second gear. As such, the pushing member 30 moves relative to the supporting assembly 10 along the first direction X, achieving pushing the excess material away from the supporting assembly 10.

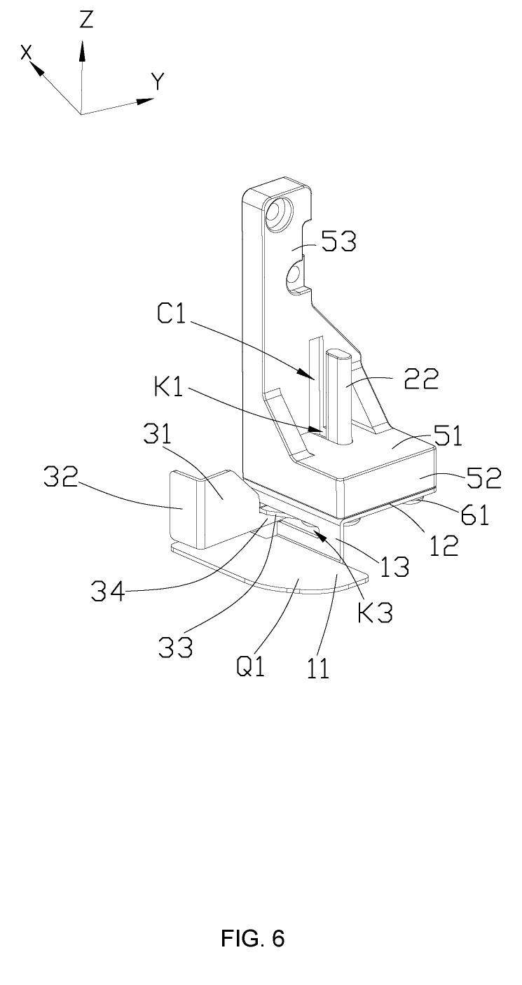

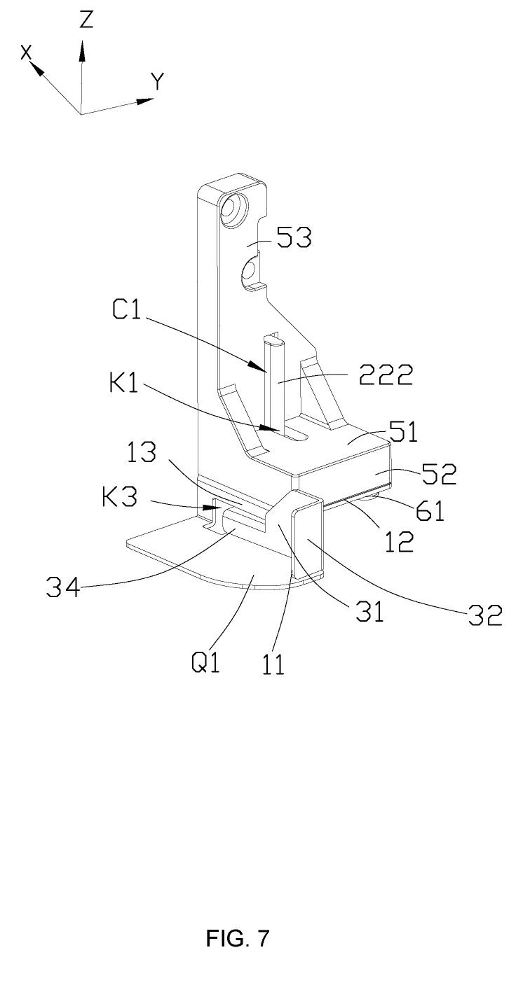

In some embodiments, referring to FIG. 6 and FIG. 7, the pushing member 30 has a first position and a second position, and the motion trajectory area Q2 of the pushing member 30 between the first position and the second position covers the material receiving area Q1. The 3D printer 200 further includes a reset member 40 connected to the pushing member 30. The transmission assembly 20 is configured to move from the second position to the first position in response to the print head 206 drives the transmission assembly 20 to move, and the reset member 40 is configured to drive the pushing member 30 to move from the first position toward the second position after the print head 206 is separated from the transmission assembly 20.

In a case that the print head 206 is spaced apart from the pushing member 30, the pushing member 30 is at the second position. After the print head 206 pushes the force receiving member 22 to move, making the pushing member 30 to move to the first position, the print head 206 is able to extrude excess material in the material receiving area Q1. After the print head 206 leaves the force receiving member 22, the reset member 40 drives the transmission assembly 20 to move, driving the pushing member 30 at the first position to move toward the second position. During the movement of the pushing member 30, the pushing member 30 is able to push the excess material in the material receiving area Q1 away from the supporting assembly 10. Therefore, excess material may be quickly removed after the print head 206 completes excess material extrusion, improving removal efficiency.

In some embodiments, referring to FIG. 3, the pushing member 30 includes a pushing plate 31 and an extension plate 32, the pushing plate 31 is transmission-connected to the transmission assembly 20, and the extension plate 32 is bent and connected to the pushing plate 31. The extension plate 32 is configured to block the consumable material extruded by the print head 206 to prevent the consumable material from flowing out from the edge of the supporting assembly 10. In FIG. 3, the pushing member 30 in solid lines is at the second position, the pushing member 30 in broken lines shows a virtual state of the pushing member 30 in the first position.

In some embodiments, in a case that the pushing member 30 is at the second position, an angle P1 between a length direction of the pushing plate 31 and the first direction X is between 50° and 120°. In a case that the pushing member 30 is at the first position, the length direction of the pushing member 30 is substantially parallel to the first direction X. Parallelism errors within a range of 5 degrees may be considered as parallel. For example, in the embodiment shown in FIG. 3, in a case that the pushing member 30 is at the second position, the pushing plate 31 may further rotate to the outside of the supporting assembly 10 to push the excess material away from the supporting assembly 10. The angle P1 is greater than 90° and less than 120°. This not only prevents collision between the pushing member 30 and the frame 202 but also enables that the pushing member 30 push the excess material away from the supporting assembly 10.

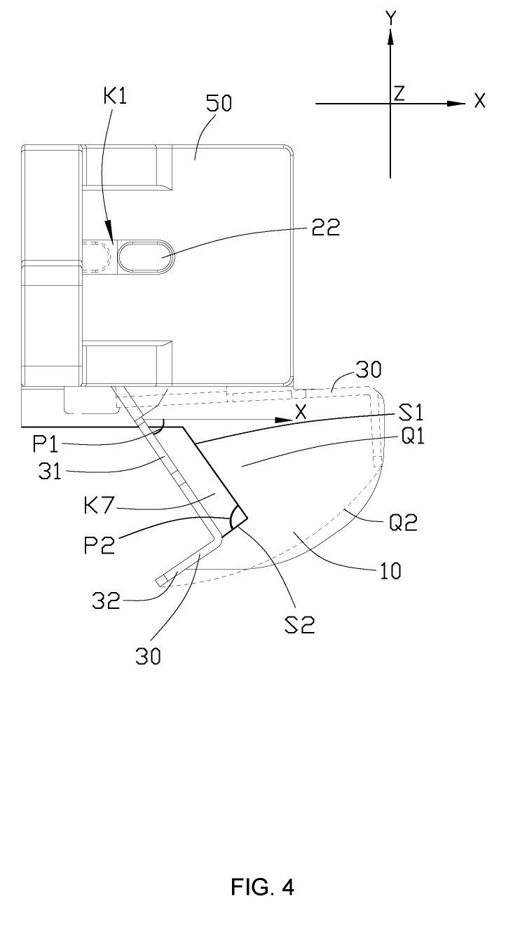

In some embodiments, referring to FIG. 4, the supporting assembly 10 includes a clearance groove K7 formed on a side close to the frame 202 along the first direction X, and the pushing member 30 is rotatable to correspond to an edge of the clearance groove K7 to push the excess material away from the supporting assembly 10 through the clearance groove K7. In FIG. 4, the pushing member 30 in solid lines is at the second position, the pushing member 30 in broken lines shows a virtual state of the pushing member 30 in the first position.

In some embodiments, referring to FIG. 4, the clearance groove K7 includes a first side edge S1 and a second side edge S2, and an angle P2 between the first side edge S1 and the second side edge S2 is smaller than 180°. In a case that the pushing member 30 is at the second position, the extension plate 32 of the pushing member 30 is substantially parallel to the second side edge S2 of the clearance groove K7, and the pushing plate 31 of the pushing member 30 is substantially parallel to the first side edge S1 of the clearance groove K7. Furthermore, at least a part of the extension plate 32 and at least a part of the pushing plate 31 are in the clearance groove K7 to enable that the pushing member 30 pushes the excess material away from the supporting assembly 10. This not only ensures the reliability of excess material removal but also further reduces the rotation space required for the pushing member 30, avoiding interference between the pushing member 30 and other parts of the 3D printer 100. In the embodiment shown in FIG. 4, in a case that the pushing member 30 is at the second position, the angle P1 between the length direction of the pushing plate 31 and the first direction X is between 50° and 60°, for example, the angle P1 may be set to 58°.

In some embodiments, the first gear 2111 includes at least three teeth, and the first rack 2211 includes at least ten teeth, thereby ensuring that the pushing member 30 is able to reciprocate between the first position and the second position. For example, the first gear 2111 may include three, four, or five or more teeth, and the first rack 2211 may include ten, eleven, or twelve or more teeth, etc.

In some embodiments, parameters of each of the teeth of the first gear 2111 and the first rack 2211 are: module of 0.5, tooth width of 5 mm to 7 mm, and pitch circle diameter of the first gear 2111 is 7 mm to 8 mm. In one embodiment, tooth width of each of the teeth of the first gear 2111 and the first rack 2211 is 6 mm, pitch circle diameter of the first gear 2111 is 7.5 mm. In other embodiments, these parameters can be adjusted according to actual assembly requirements and processing precision.

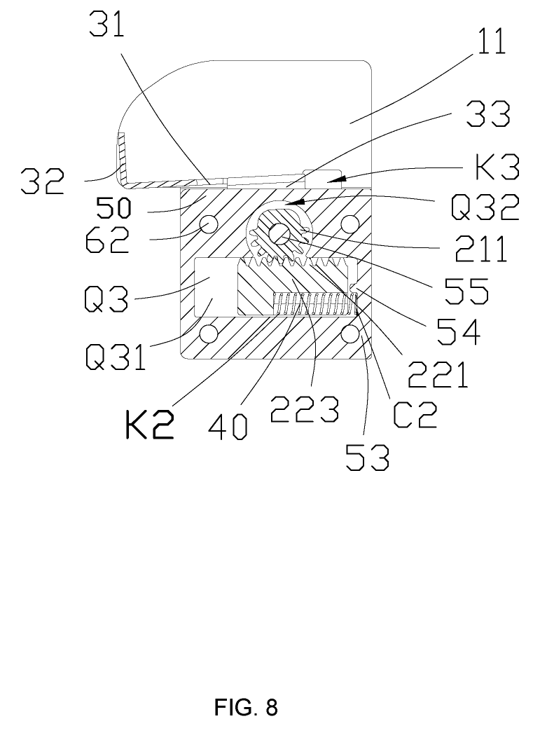

In some embodiments, referring to FIG. 8, the reset member 40 includes an elastic structure connected to the transmission assembly 20. In a case that the pushing member 30 is at the first position, the elastic structure is elastically deformed and is configured to apply an elastic force to the transmission assembly 20. In a case that the pushing member 30 is at the second position, the elastic structure is relaxed.

In a case that the print head 206 approaches the supporting assembly 10 and pushes the force receiving portion 222 to move, the pushing member 30 switches from the second position to the first position in response to the pushing member 30 is driven by the first transmission portion 221. In a case that the nozzle 207 of the print head 206 corresponds to the material receiving area Q1, the pushing member 30 is at the first position, and the print head 206 extrudes excess material toward the material receiving area Q1. After the print head 206 completing the excess material extrusion action and moves away from the supporting assembly 10, the pushing member 30 moves from the first position toward the second position in response to the pushing member 30 is pushed by the elastic force of the elastic structure, pushing the excess material away from the supporting assembly 10.

The elastic structure may be constructed in various forms with elastic force, such as springs, tension springs, elastic strips, or elastic columns.

In other embodiments, the reset member 40 may be a drive structure such as a motor.

In some embodiments, referring to FIG. 7 and FIG. 8, the 3D printer 200 further includes a base member 50. The base member 50 is fixedly connected to the Z-axis drive assembly 205 or the frame 202. One end of the supporting assembly 10 is connected to the base member 50. The elastic structure is connected between the base member 50 and the transmission assembly 20. One side of the elastic structure abuts against the force receiving portion 222, and another side of the elastic structure abuts against the base member 50.

In some embodiments, referring to FIG. 7, the base member 50 includes a first guide hole K1. The force receiving portion 222 passes through the first guide hole K1. The first guide hole K1 is configured to guide the force receiving portion 222 to move along the first direction X. During the process in a case that the print head 206 pushes the force receiving portion 222 to move, the first direction X ensures that the movement direction of the force receiving portion 222 is along the first direction X, thereby improving movement accuracy of the first rack 2211 along the first direction X, and further improving rotation precision of the first gear 2111. Additionally, during the process in a case that the elastic structure drives the first transmission portion 221 to reset to the second position, the first guide hole K1 may further guide the force receiving portion 222 to move along the first direction X and provide a limiting function for the force receiving portion 222, making that the elastic structure drives the first rack 2211 to move along the first direction X. Optionally, the first guide hole K1 may be an elongated hole with a length direction of the first guide hole K1 parallel to the first direction X.

In some embodiments, referring to FIG. 7 and FIG. 8, the base member 50 includes a peripheral wall 52 and a top wall 51. The peripheral wall 52 is connected to a periphery of the top wall 51. The supporting assembly 10 includes a mounting plate 12. The top wall 51 is spaced apart from the mounting plate 12 along the first direction X. The peripheral wall 52 is connected between the top wall 51 and the mounting plate 12, and a receiving cavity Q3 is formed between the peripheral wall 52, the top wall 51, and the mounting plate 12. One end of the elastic structure abuts against the first transmission portion 221, and the other end of the elastic structure abuts against the peripheral wall 52.

The first transmission portion 221 and the second transmission portion 211 are arranged in the receiving cavity Q3. The first guide hole K1 is defined on the top wall 51. The force receiving portion 222 passes through the first guide hole K1 and protrudes to a side of the top wall 51 away from the mounting plate 12, making the force receiving portion 222 convenient to contact with the print head 206 so that the print head 206 can drive the force receiving portion 222 to move.

In some embodiments, referring to FIG. 8, the 3D printer 200 further includes multiple first fasteners 62. The multiple first fasteners 62 are fixedly connected to the mounting plate 12 and the peripheral wall 52 of the base member 50 to achieve fixed connection between the supporting assembly 10 and the base member 50. In some embodiments, the peripheral wall 52 is rectangular. There are four first fasteners 62, which are respectively disposed at the four corners of the peripheral wall 52.

In some embodiments, referring to FIG. 8, the transmission assembly 20 further includes a mounting block 223. The mounting block 223 is connected to the first transmission portion 221. A second guide hole K2 is formed on one side of the mounting block 223. A through direction of the second guide hole K2 is parallel to the first direction X. The elastic structure is arranged in the second guide hole K2. As such, the second guide hole K2 restricts the deformation direction of the elastic structure to ensure that the direction of the elastic force of the elastic structure is parallel to the first direction X, improving the reset reliability of the elastic structure.

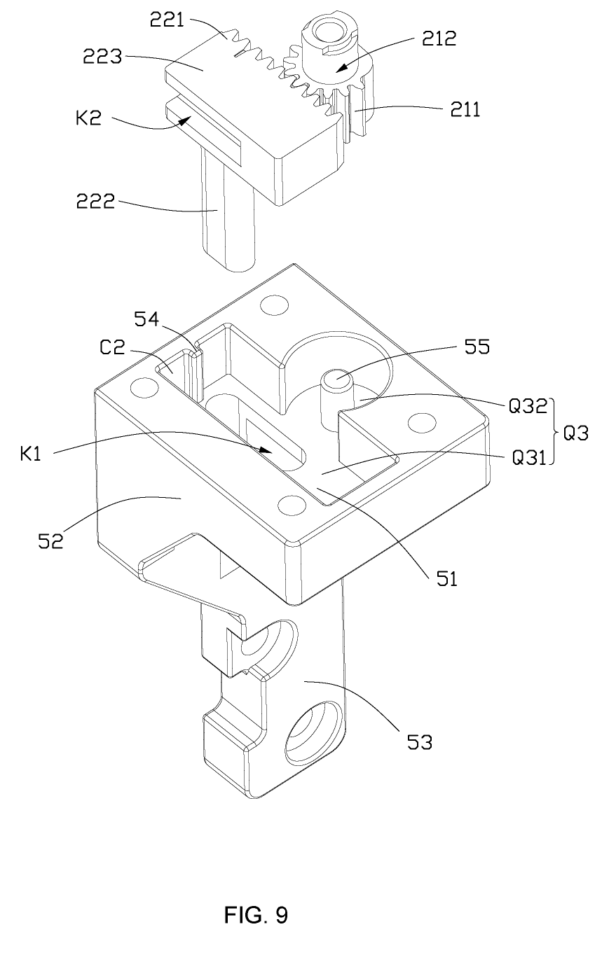

In some embodiments, referring to FIG. 8 and FIG. 9, the base member 50 further includes a limiting protrusion 54. The limiting protrusion 54 is connected to the peripheral wall 52 and forms a limiting groove C2 with the peripheral wall 52. The other end of the elastic structure is fitted within the limiting groove C2. Through the cooperation of the limiting groove C2 and the second guide hole K2, achieving that the deformation direction of the elastic structure is parallel to the first direction X.

In some embodiments, referring to FIG. 7 and FIG. 8, the receiving cavity Q3 includes a first sub-cavity Q31 and a second sub-cavity Q32. The first sub-cavity Q31 communicates with the second sub-cavity Q32. The first rack 2211 is movably arranged in the first sub-cavity Q31 along the first direction X. The base member 50 further includes a mounting post 55. The mounting post 55 is connected to the top wall 51 and is arranged in the second sub-cavity Q32. The mounting post 55 is configured to rotatably fit with the first gear 2111.

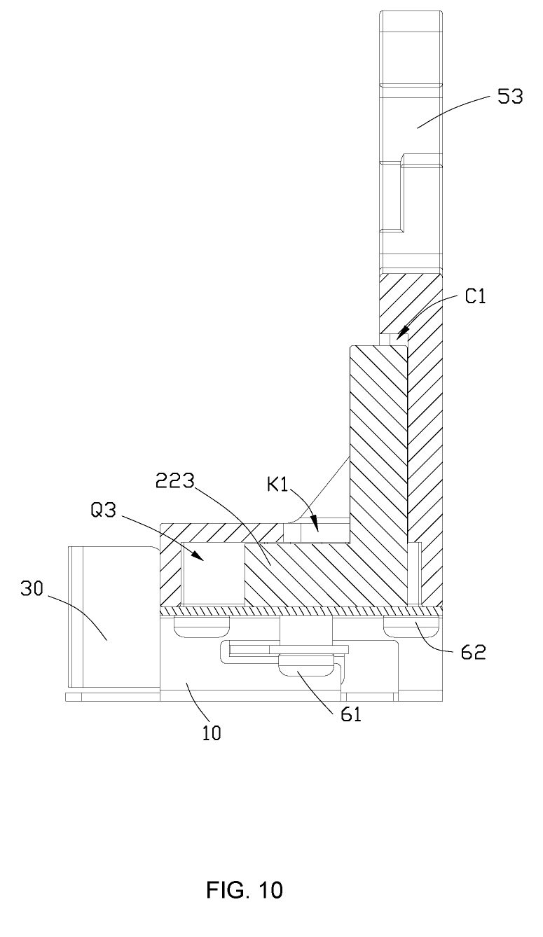

In some embodiments, referring to FIG. 10, the base member 50 further includes a connecting wall 53. The connecting wall 53 is connected to the side of the top wall 51 away from the mounting plate 12 and extends along the third direction Z. The connecting wall 53 is configured to connect to the frame 202 or the Z-axis drive assembly 205 to fixedly mount the base member 50 and the supporting assembly 10. In some embodiments, a length direction of the force receiving portion 222 is parallel to the third direction Z to increase the contact dimension between the print head 206 and the force receiving portion 222, improving the movement stability of the force receiving portion 222 driven by the print head 206. A clearance groove C1 is formed on a side of the connecting wall 53 close to the first guide hole K1 along the first direction X. The clearance groove C1 extends along the third direction Z and is configured to provide clearance for the force receiving portion 222.

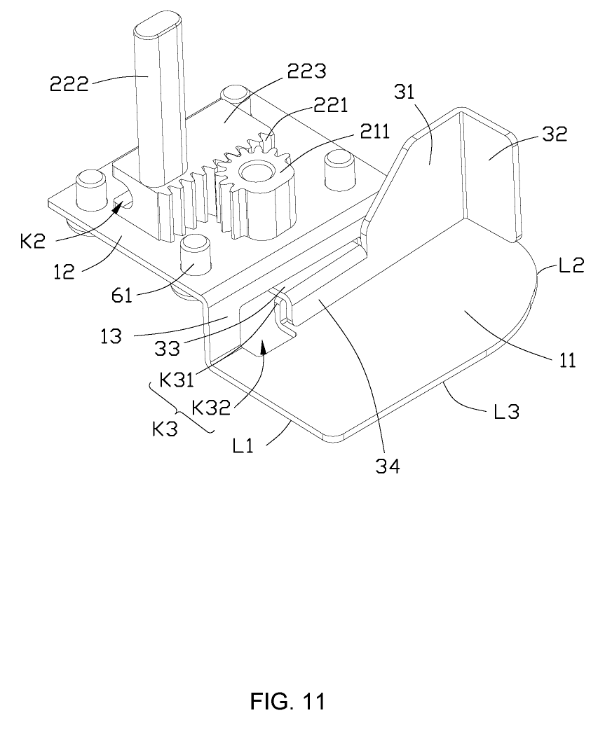

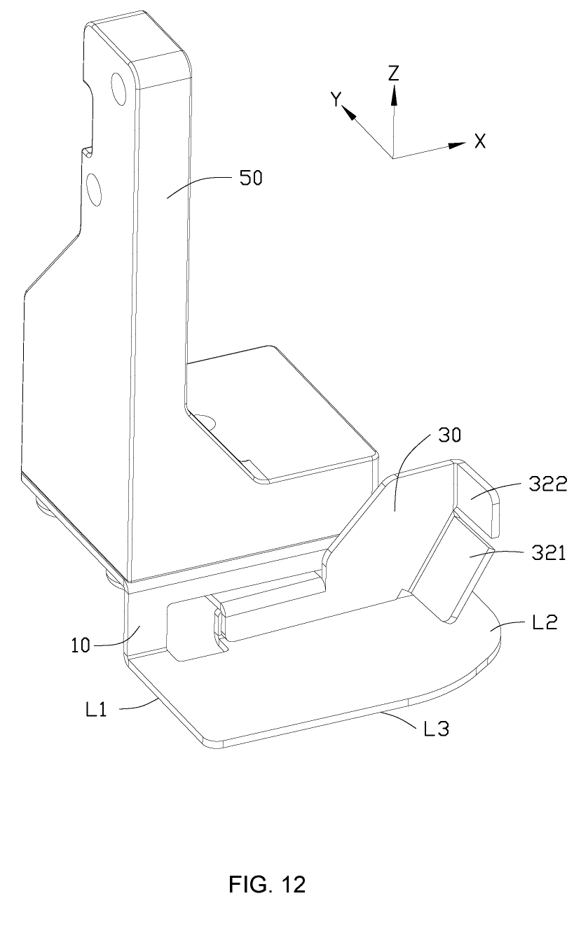

In some embodiments, referring to FIG. 11 and FIG. 12, in the motion trajectory area Q2 of the pushing member 30, the pushing plate 31 is at the inner side of the supporting assembly 10, and at least a portion of the extension plate 32 is at the outer side of the supporting assembly 10. In a case that the size of the supporting assembly 10 is small, the extension plate 32 may provide some receiving area to prevent excess material from the print head 206 from falling outside the supporting assembly 10 and contaminating the base 201, frame 202, or forming platform 208 of the printer, ensuring that all excess material falls onto the supporting assembly 10 and improving the reliability of excess material removal.

In some embodiments, referring to FIG. 11 and FIG. 12, the extension plate 32 includes a first plate segment 321 and a second plate segment 322. The second plate segment 322 is at a side of the first plate segment 321 away from the supporting assembly 10. The first plate segment 321 extends obliquely to the outer side of the supporting assembly 10, and a plate surface of the first plate segment 321 intersects with the material receiving area Q1. A plate surface of the second plate segment 322 is perpendicular to the material receiving area Q1. The first plate segment 321 and the second plate segment 322 may be formed on the pushing plate 31 through sheet metal processing, reducing the processing difficulty of the pushing member 30. In other embodiments, the extension plate 32 may be an integral inclined plate structure and connected to the pushing plate 31 through screwing, welding, or other connection methods.

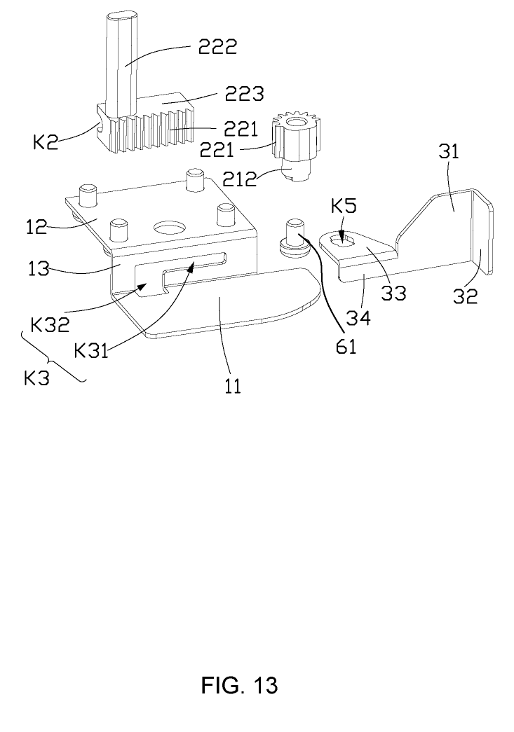

In some embodiments, referring to FIG. 13, the pushing plate 31, the extension plate 32, the first connecting plate 33, and the second connecting plate 34 are integrally formed structures. The second connecting plate 34 is connected to one end of the pushing plate 31. The first connecting plate 33 is bent and connected to the second connecting plate 34. The extension plate 32 is bent and connected to the other end of the pushing plate 31. A bending direction of the extension plate 32 is different from a bending direction of the first connecting plate 33. In a case that the pushing member 30 is at the first position, the pushing plate 31 and the second connecting plate 34 extend along the first direction X; the extension plate 32 extends along the third direction Z and is bent and connected to one side of the pushing plate 31 along the second direction Y; the first connecting plate 33 extends along the second direction Y and is bent and connected to the other side of the pushing plate 31 along the second direction Y.

In some embodiments, referring to FIG. 11, the supporting assembly 10 includes a receiving plate 11 and a mounting plate 12. The receiving plate 11 is arranged on one side of the mounting plate 12, the material receiving area Q1 is disposed on a surface of the receiving plate 11, the transmission assembly 20 is arranged on the mounting plate 12. The pushing member 30 includes a first connecting plate 33 and a pushing plate 31, the first connecting plate 33 is connected to the transmission assembly 20, the pushing plate 31 is arranged on the receiving plate 11, and the pushing plate 31 is configured to push the excess material away from the receiving plate 11 in response to the first connecting plate 33 drives the pushing plate 31 to move.

In some embodiments, referring to FIG. 11, the supporting assembly 10 further includes a transition plate 13. One side of the transition plate 13 is connected to the receiving plate 11, and another side of the transition plate 13 is connected to the mounting plate 12. The transition plate 13 includes a clearance hole K3. The first connecting plate 33 extends through the clearance hole K3 and connects to the transmission assembly 20. The pushing plate 31 is connected to a side of the first connecting plate 33 extending out of the clearance hole K3. A plate surface of the pushing plate 31 intersects with a plate surface of the receiving plate 11. The clearance hole K3 is configured to limit range of movement of the first connecting plate 33.

In some embodiments, referring to FIG. 11, the clearance hole K3 includes a first hole segment K31 and a second hole segment K32. The first hole segment K31 is located on one side of the second hole segment K32 along the first direction X. The first hole segment K31 is formed in the transition plate 13, and the second hole segment K32 extends through from the transition plate 13 to the receiving plate 11. In a case that the pushing member 30 is at the first position, the first connecting plate 33 extends through the first hole segment K31. During the process of the pushing member 30 rotating from the first position toward the second position, the first connecting plate 33 rotates toward the second hole segment K32, while the second connecting plate 34 gradually slides into the second hole segment K32 until the second connecting plate 34 abuts against an edge of the transition plate 13 near the second hole segment K32, making the pushing member 30 to enter the second position.

In some embodiments, referring to FIG. 12, the receiving plate 11 includes a first edge L1 and a second edge L2 arranged oppositely along the first direction X, with the material receiving area Q1 located between the first edge L1 and the second edge L2. The receiving plate 11 further includes a third edge L3 on the side away from the mounting plate 12. The third edge L3 connects between the first edge L1 and the second edge L2. In a case that the pushing member 30 is at the first position, the length direction of the pushing plate 31 is parallel to the first direction X, the extension plate 32 is at an outer side of the first edge L1 away from the second edge L2. The second edge L2 is arc-shaped, and during the rotation of the pushing member 30 toward the first position or the second position, the movement trajectory of the extension plate 32 is tangent to the second edge L2, reducing occupied space of the receiving plate 11 and avoid interference between the receiving plate 11 and other components of the 3D printer 200.

In some embodiments, referring to FIG. 13, the mounting plate 12 and the receiving plate 11 are spaced apart along the third direction Z, and the receiving plate 11 is at one side of the mounting plate 12 along the second direction Y. The supporting assembly 10 further includes a transition plate 13. The transition plate 13 is connected between the receiving plate 11 and the mounting plate 12. The first connecting plate 33 is between the receiving plate 11 and the mounting plate 12, and is connected to the second transmission portion 211 on the mounting plate 12. The second transmission portion 211 includes a connecting portion 212. The 3D printer 200 further includes a second fastener 61. The second fastener 61 fixedly connects the first connecting plate 33 and the second transmission portion 211.

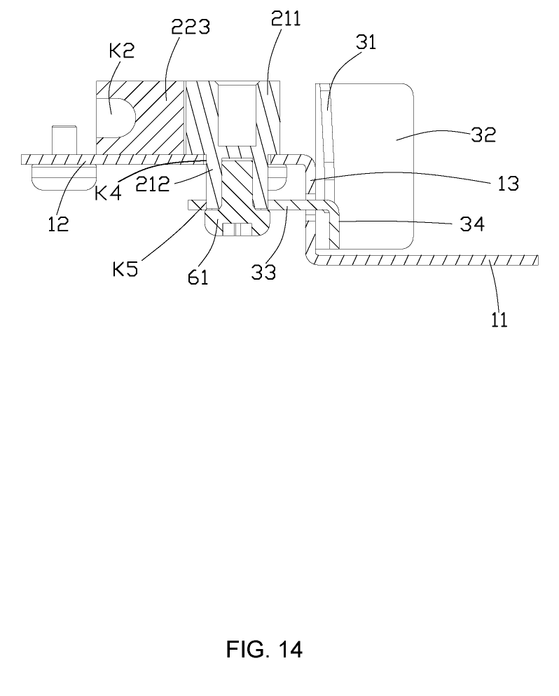

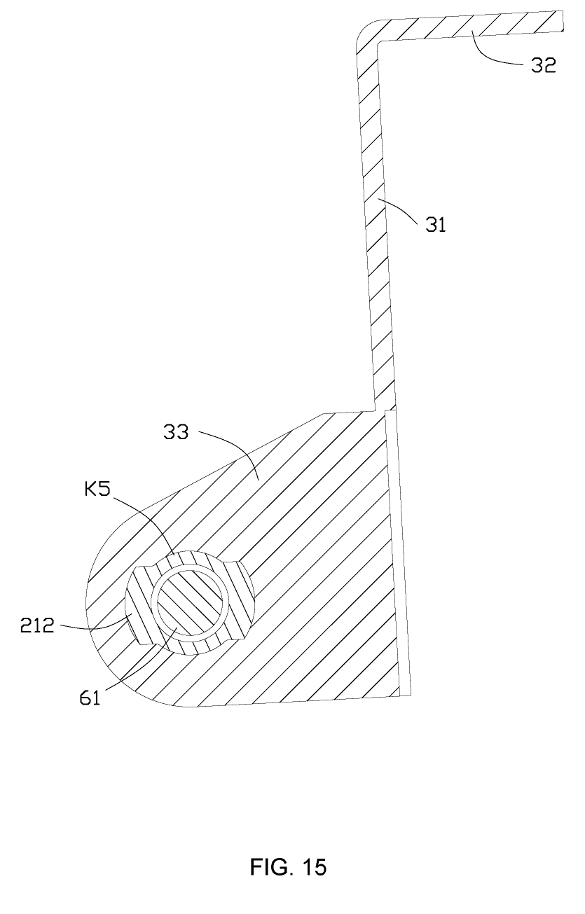

In some embodiments, referring to FIG. 14 and FIG. 15, the mounting plate 12 includes a connecting hole K4. The first connecting plate 33 includes a limiting hole K5, the connecting portion 212 passes through the connecting hole K4, and the second fastener 61 extends through the limiting hole K5 and connects with the connecting portion 212 to fix the first connecting plate 33 to the first transmission portion 221, thereby achieving the rotation of the first connecting plate 33 driven by the first transmission portion 221. A shape of the limiting hole K5 may be irregular, rectangular, elliptical, or various other shapes to prevent relative rotation between the connecting portion 212 and the first connecting plate 33, thereby improving the connection reliability between the connecting portion 212 and the first connecting plate 33. The second fastener 61 may be various fastening structures such as screws, pins, etc.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A 3D printer, comprising:
a print head,
a supporting assembly, comprising a material receiving area configured to receive excess material extruded from the print head;
a transmission assembly movably arranged on the supporting assembly; and
a pushing member rotatably connected to the transmission assembly, and comprising a motion trajectory area, wherein the motion trajectory area covers at least a part of the material receiving area, and the transmission assembly is configured to drive the pushing member to rotate relative to the supporting assembly thereby pushing the excess material away from the supporting assembly.

2. The 3D printer according to claim 1, wherein:
the transmission assembly comprises a transmission member and a force receiving member, one end of the transmission member is transmission-connected to the force receiving member, and another end of the transmission member is connected to the pushing member, and the force receiving member is configured to drive the transmission member to move relative to the supporting assembly in response to the force receiving member is pushed by the print head, thereby driving the pushing member to rotate relative to the supporting assembly.

3. The 3D printer according to claim 2, wherein:
the force receiving member comprises a force receiving portion and a first transmission portion, the force receiving portion is connected to the first transmission portion, and the force receiving portion is configured to drive the first transmission portion to move in response to the force receiving portion is pushed by the print head;
the transmission member comprises a second transmission portion, the second transmission portion is rotatably connected to the first transmission portion, the second transmission portion is further connected to the pushing member, and in response to the first transmission portion drives the second transmission portion to rotate, the second transmission portion drives the pushing member to rotate relative to the supporting assembly.

4. The 3D printer according to claim 3, wherein:
the first transmission portion comprises a first rack, the second transmission portion comprises a first gear, and the first rack meshes with the first gear.

5. The 3D printer according to claim 4, wherein:
the pushing member is selectively rotatable between a first position and a second position, and the motion trajectory area of the pushing member between the first position and the second position covers at least a part of the material receiving area;
in a case that the pushing member is at the second position, an angle between the pushing member and a first direction is between 50° and 120°; and in a case that the pushing member is at the first position, the pushing member is parallel to the first direction.

6. The 3D printer according to claim 4, wherein:
the first gear comprises at least three teeth, and the first rack comprises at least ten teeth.

7. The 3D printer according to claim 6, wherein:
each of a module of the teeth of the first gear and a module of the teeth of the first rack is 0.5, a tooth width of the teeth of the first gear and a tooth width of the teeth of the first rack are between 5 mm and 7 mm, and a diameter of a pitch circle of the first gear is between 7 mm and 8 mm.

8. The 3D printer according to claim 2, wherein:
the pushing member is selectively rotatable between a first position and a second position, and a motion trajectory area of the pushing member between the first position and the second position covers at least a part of the material receiving area;
the 3D printer further comprises a reset member connected to the pushing member, the pushing member is rotatable from the second position to the first position in response to the print head drives the pushing member to rotate, and the reset member is configured to drive the pushing member to rotate from the first position toward the second position after the print head is separated from the transmission assembly.

9. The 3D printer according to claim 8, wherein:
the reset member comprises an elastic structure connected to the transmission assembly, in the case that the pushing member is at the first position, the elastic structure is elastically deformed and configured to apply an elastic force to the transmission assembly, and in the case the pushing member is at the second position, the elastic structure is relaxed.

10. The 3D printer according to claim 1, wherein:
the supporting assembly comprises a clearance groove defined on a side close to a frame along a first direction, and in response to the pushing member is rotated to correspond to an edge of the clearance groove, the pushing member pushes the excess material away from the supporting assembly through the clearance groove.

11. The 3D printer according to claim 10, wherein:
the clearance groove comprises a first side edge and a second side edge, and an angle between the first side edge and the second side edge is smaller than 180°;
the pushing member comprises a pushing plate and an extension plate, the pushing plate is transmission-connected to the transmission assembly, the extension plate is connected to the pushing plate, in a case that the pushing member is rotated to correspond to the clearance groove, the pushing plate is parallel to the first side edge, and the extension plate is parallel to the second side edge.

12. The 3D printer according to claim 1, wherein:
the pushing member comprises a pushing plate and an extension plate, the pushing plate is transmission-connected to the transmission assembly, the extension plate is connected to the pushing plate, and at least a portion of the extension plate is at an outer side of the supporting assembly.

13. The 3D printer according to claim 12, wherein:
the pushing member is selectively rotatable between a first position and a second position, and the motion trajectory area of the pushing member between the first position and the second position covers at least a part of the material receiving area;
the extension plate is bent and connected to the pushing plate, in a case that the pushing member is at the second position, the pushing plate is parallel to a side of the supporting assembly, and the extension plate extends out of the supporting assembly.

14. The 3D printer according to claim 1, wherein:
the supporting assembly comprises a receiving plate and a mounting plate, the receiving plate is arranged on one side of the mounting plate, the material receiving area is disposed on a surface of the receiving plate, the transmission assembly is arranged on the mounting plate;
the pushing member comprises a first connecting plate and a pushing plate, the first connecting plate is connected to the transmission assembly, the pushing plate is arranged on the receiving plate, and the pushing plate is configured to push the excess material away from the receiving plate in response to the first connecting plate drives the pushing plate to move.

15. The 3D printer according to claim 14, wherein:
the supporting assembly further comprises a transition plate, one side of the transition plate is connected to the receiving plate, and another side of the transition plate is connected to the mounting plate;
the transition plate comprises a clearance hole, the first connecting plate extends through the clearance hole and connects to the transmission assembly, the pushing plate is connected to a side of the first connecting plate extending out of the clearance hole, a plate surface of the pushing plate intersects with a plate surface of the receiving plate, the clearance hole is configured to limit a range of movement of the first connecting plate.

16. The 3D printer according to claim 9, wherein the 3D printer further comprises:
a base member, one end of the supporting assembly is connected to the base member, the elastic structure is connected between the base member and the transmission assembly, one side of the elastic structure abuts against the force receiving member, and another side of the elastic structure abuts against the base member.

17. The 3D printer according to claim 16, wherein:
the base member comprises a first guide hole, the force receiving member passes through the first guide hole, the first guide hole is configured to guide the force receiving member to move along a first direction.

18. The 3D printer according to claim 17, wherein:
the base member comprises a peripheral wall and a top wall, the peripheral wall is connected to a periphery of the top wall;
the supporting assembly comprises a mounting plate, the top wall is spaced apart from the mounting plate along the first direction, the peripheral wall is connected between the top wall and the mounting plate;
a receiving cavity is formed between the peripheral wall, the top wall, and the mounting plate, one end of the elastic structure abuts against the force receiving member, and another end of the elastic structure abuts against the peripheral wall;
the first guide hole is defined on the top wall.

19. The 3D printer according to claim 18, wherein:
the receiving cavity comprises a first sub-cavity and a second sub-cavity, the first sub-cavity communicates with the second sub-cavity, a part of the force receiving member is movably arranged in the first sub-cavity;
the base member further comprises a mounting post, the mounting post is connected to the top wall and is arranged in the second sub-cavity, the mounting post is rotatably fit another part of the force receiving member.

20. The 3D printer according to claim 18, wherein:
the base member further comprises a connecting wall, the connecting wall is connected to a side of the top wall away from the mounting plate, the connecting wall is configured to connect to a frame.
